(19) United States
(12) Patent Application Publication
(10) Pub. No.: US 2012/0002790 A1
(43) Pub. Date: Jan. 5, 2012

(54) RADIOGRAPHIC APPARATUS

(76) Inventor: Masahiro Tanaka, Shiga (JP)

(21) Appl. No.: 13/256,911

(22) PCT Filed: Mar. 26, 2009
(86) PCT No.: PCT/JP2009/001364

§ 371 Date: Sep. 15, 2011

(51) Int. Cl. H05G 1/02

(52) U.S. Cl. 378/198

(57) ABSTRACT

The object of this invention is to provide a radiographic apparatus with an image pickup line movable faithfully to instructions from the operator. That is, according to the construction of this invention, an additional movement controller can carry out feedback control for recurrently controlling movement of an image pickup line. Moreover, the construction of this invention is characterized in that an acceleration acquiring unit acquires an acceleration of the image pickup line. That is, when the velocity of the image pickup line approaches a predetermined velocity, the acceleration of the movable object will be brought close to 0. In this way, overshooting can be inhibited, and the phenomenon of the movable object clattering each time it moves can be prevented reliably, thereby providing an X-ray apparatus excellent in operability.

### TECHNICAL FIELD

This invention relates to a radiographic apparatus capable of acquiring fluoroscopic images of patients, and more particularly to a radiographic apparatus in which a radiation source and a radiation detector can be moved relative to a top board.

### BACKGROUND ART

A medical institution has a radiographic apparatus installed therein for acquiring fluoroscopic images of patients. A conventional construction of such a radiographic apparatus will be described. A conventional radiographic apparatus 51, as shown in FIG. 9, includes a top board 52 for supporting a patient M, a radiation source 53 disposed below the top board 52, and a radiation detecting device (I.I tube) 54 disposed above the top board 52. The radiation source 53 and I.I tube 54 are movable along the body axis direction A of the patient M relative to the top board 52. The radiation source 53 and I.I tube 54 are movable relative to the top board 52, while maintaining a relative positional relationship, and the two may be collectively called an image pickup line.

When acquiring fluoroscopic images, the patient M is made to lie with the face turned upward on the top board 52. However, some radiographic apparatus 51 are constructed capable of radiographing the patient M in a standing position. Such a radiographic apparatus 51 can stand the top board 52 relative to the floor of an examination room as shown in FIG. 10, and can also lay down the top board 52 to be horizontal to the floor as shown in FIG. 9. The radiation source 53 and I.I tube 54, while maintaining the relative positional relationship with the top board 52, move following this tilting movement of the top board 52. That is, the radiation source 53 and I.I tube 54 are moved together with the top board 52. Such construction is described in Patent Document 1 and Patent Document 2, for example.

The I.I tube 54 is movable in the body axis direction of the patient M relative to the top board 52, and the position of the I.I tube 54 is changed by a drive motor 63 driving the I.I tube 54. That is, as shown in FIG. 11, the radiographic apparatus 51 has two pulleys 60a and 60b arranged in the body axis direction of the patient M, and a belt 61 is wound around these pulleys.

The belt 61 is connected to a strut 54a supporting the I.I tube 54, and to a balance weight 62 which has a weight comparable to the I.I tube 54 and strut 54a. The drive motor 63 drives either one of the two pulleys 60a and 60b, whereby the I.I tube 54 will be moved back and forth along the body axis direction A. The pulley 60a, pulley 60b, belt 61 and balance weight 62 are mounted in the radiographic apparatus 51.

The balance weight 62 assumes a role important to the radiographic apparatus 51 which employs a construction for freely standing up and laying down the top board 52. That is, when an attempt is made to raise the top board 52 from a lying position, the I.I tube 54 will tend to slide down together with the strut 54a relative to the top board 52 as indicated by dotted line arrows in FIG. 12. The balance weight 62 is provided in order to prevent this. The balance weight 62 and I.I tube 54 are arranged in positions to pull each other about the pulley 60b when the top board 52 is tilted. That is, the I.I tube 54 and balance weight 62 pull each other through the belt 61 so as to cancel the mutual slide down movements. In this way, without the I.I tube 54 sliding down with ups and downs of the top board 52, the operator can set the I.I tube 54 to a specified position relative to the top board 52.
[Patent Document 1] Unexamined Patent Publication No. 2000-23957
[Patent Document 2] Unexamined Patent Publication H11-137543

### DISCLOSURE OF THE INVENTION

### Problem to be Solved by the Invention

However, such conventional construction has the following problem.

That is, according to the conventional construction, it is difficult to move the I.I tube 54 as instructed. With the balance weight 62 provided, large torque is required when starting the belt 61. Therefore, a situation could arise where the number of rotations of the drive motor 63 is smaller than is commanded, due to a torque shortage of the drive motor 63. In addition, the force of inertia which resists braking of the belt 61 is also strong. Therefore, when an attempt is made to cause the drive motor 63 to slow the belt 61 in order to stop movement of the I.I tube 54, a situation will arise this time where the number of rotations of drive motor 63 is larger than is commanded. Thus, the presence of the balance weight 62 makes it all the more difficult to move the I.I tube 54 as instructed.

In view of such a situation, there is also a construction among conventional examples, which compensates for the shortage of rotations of the drive motor 63 by using feedback control for the drive motor 63. However, even with such construction, it is difficult to move the I.I tube 54 as instructed. That is, when the drive motor 63 does not rotate as instructed, the drive motor 63 will be accelerated by the feedback control. Then, the drive motor 63 will unnecessarily be accelerated to excess. Then, the feedback control works to slow down the drive motor 63. Then, this time it will unnecessarily be decelerated to excess. That is, as shown in FIG. 13, moving velocity V of the I.I tube 54 will bound to cross a predetermined velocity K several times (such a phenomenon being called overshooting). That is, the I.I tube 54 moves with a clatter. Since the I.I tube 54 moves while vibrating, the conventional radiographic apparatus 51 will give a feeling of extraordinary complication to the operator.

This invention has been made having regard to the state of the art noted above, and its object is to provide a radiographic apparatus with an image pickup line movable faithfully to instructions from the operator.

### Means for Solving the Problem

To fulfill the above object, this invention provides the following construction.

The invention provides a radiographic apparatus having a top board, a radiation source for emitting radiation beams to the top board, a radiation detecting device for detecting the radiation beams, a radiation source moving device for moving the radiation source back and force in a predetermined direction relative to the top board, a radiation source movement control device for controlling this, a detector moving device for moving the radiation detecting device back and force in the predetermined direction relative to the top board, a detector movement control device for controlling this, and an instruction input device for inputting instructions for movement of a movable object which is at least one of the radiation source and the radiation detecting device; the radiographic apparatus comprising a target velocity acquiring device for acquiring a target velocity, which is a target moving velocity of the movable object, based on input of the instruction input device; a position information acquiring device for acquiring position information showing positions of the movable object relative to the top board; an actual velocity acquiring device for acquiring an actual velocity of the movable object, based on the position information; an acceleration acquiring device for acquiring an acceleration of the movable object based on the actual velocity; a velocity difference acquiring device for acquiring a velocity difference by subtracting the actual velocity from the target velocity; and an additional movement control device for additionally moving the movable object to compensate for the velocity difference; wherein the additional movement control device is arranged to move the movable object to bring the acceleration close to 0.

[Functions and effects] According to the construction of this invention, an actual velocity which is a moving velocity of the movable object is acquired, and a velocity difference is obtained by subtracting the above actual velocity from a target velocity which is based on instructions of the operator. A controlled variable of movement of the movable object (controlled variable) is additionally increased so as to compensate for the velocity difference. This construction enables feedback control for recurrently controlling the movement of the movable object. Moreover, the construction of this invention is characterized by obtaining acceleration of the movable object. For providing the radiographic apparatus capable of moving the movable object as specified by the operator, it is important to monitor acceleration of the movable object. That is, when the actual velocity is slightly lower than the target velocity, and the movable object is moved by additionally increasing the controlled variable without regard to the acceleration of the movable object, the actual velocity will exceed the target velocity, the actual velocity becoming slightly higher than the target velocity. When an attempt is made to bring it to the target velocity, the actual velocity will then become less than the target velocity. In this way, overshooting of the actual velocity will take place.

However, according to this invention, when the actual velocity is close to the target velocity, and the acceleration of the movable object is large, the acceleration of the movable object is brought close to 0. Here, the controlled variable for bringing the acceleration close to 0 is an additional controlled variable which is a component of the velocity difference noted above and a component of a ratio of the current acceleration to the velocity difference added together as respectively weighted. In this way, the actual velocity will gradually approach the target velocity, and the actual velocity will never increase or decrease across the target velocity. Then, the above overshooting can be inhibited, and the phenomenon of the movable object clattering each time it moves can be prevented reliably, thereby providing the radiographic apparatus excellent in operability.

It is preferable to further provide a set value storage device for storing a velocity difference setting to be referred to by the additional movement control device, wherein the additional movement control device is arranged, when the velocity difference is smaller than the velocity difference set value, to move the movable object to bring the acceleration close to 0.

[Functions and effects] According to the above construction, when the velocity difference is smaller than the velocity difference set value, the additional movement control device brings the acceleration of the movable object close to 0. With this arrangement, the image pickup line can be moved with increased reliability since the acceleration does not approach 0 at the time of starting movement of the image pickup line.

It is preferable that the movable object is the radiation detecting device.

[Functions and effects] The above construction can provide, with increased reliability, a radiographic apparatus excellent in operability. An image intensifier may be mentioned as a specific construction of the radiation detecting device. This is a heavy load difficult to move as instructed by the operator. According to the above construction, even when moving a heavy load, the movement is not accompanied by clattering.

It is preferable that the position information acquiring device is a potentiometer.

[Functions and effects] The above construction represents a specific embodiment of this invention. The potentiometer includes a rod and a slide, and is constructed to have the potential of the slide variable with movement of the slide on the rod. By employing such potentiometer as the position information acquiring device, positions of the movable object relative to the top board can be grasped at low cost and reliably.

It is preferable to further provide a top board raising and lowering mechanism for raising and lowering the top board, and a top board raising and lowering control device for controlling this; wherein the top board is arranged to stand up with one end in a longitudinal direction thereof moving upward, the top board standing up being arranged to lie down with the one end in the longitudinal direction thereof moving downward; the to radiation source, the radiation source moving device, the radiation detecting device and the detector moving device are arranged, when the top board is raised and lowered, to move with the top board while maintaining a positional relationship with the top board; and the predetermined direction is the longitudinal direction of the top board.

[Functions and effects] The above construction can raise and lower the top board. That is, the top board can be stood up relative to the floor of the examination room, and can also be laid down, according to purposes of examination.

It is preferable that the set value storage device is arranged to store also a first weighting coefficient and a second weighting coefficient, and a controlled variable of additional movement made by the additional movement control device is a sum of the velocity difference multiplied by the first weighting coefficient and a ratio of the acceleration to the velocity difference multiplied by the second weighting coefficient.

[Functions and effects] The above construction represents a specific embodiment of this invention. With the above construction, a controlled variable of additional movement can be determined, reliably taking the velocity difference and acceleration into account.

### Effects of the Invention

According to the construction of this invention, feedback control can be carried out for recurrently controlling movement of a movable object. Moreover, the construction of this invention is characterized by determination of an acceleration of the movable object. That is, when the velocity of the movable object approaches a predetermined velocity, the acceleration of the movable object will be brought close to 0. In this way, overshooting can be inhibited, and the phenomenon of the movable object clattering each time it moves can be prevented reliably, thereby providing a radiographic apparatus excellent in operability.

### BRIEF DESCRIPTION OF THE DRAWINGS

FIG. 1 is a functional block diagram illustrating a construction of an X-ray apparatus according to Embodiment 1;

FIG. 2 is a flow chart illustrating operation of a radiographic apparatus according to Embodiment 1;

FIG. 3 is a schematic view showing velocity variations of an image pickup line according to Embodiment 1;

FIG. 4 is a flow chart illustrating operation of an additional movement control unit according to Embodiment 1;

FIG. 5 is a schematic view showing velocity variations of the image pickup line according to Embodiment 1;

FIG. 6 is a schematic view showing velocity variations of the image pickup line according to Embodiment 1;

FIG. 7 is a functional block diagram illustrating a construction of an X-ray apparatus according to one modification of this invention;

FIG. 8 is a functional block diagram illustrating the construction of the X-ray apparatus according to the one modification of this invention;

FIG. 9 is a schematic view illustrating a construction of a conventional radiographic apparatus;

FIG. 10 is a schematic view illustrating the construction of the conventional radiographic apparatus;

FIG. 11 is a schematic view illustrating the construction of the conventional radiographic apparatus;

FIG. 12 is a schematic view illustrating the construction of the conventional radiographic apparatus; and

FIG. 13 is a schematic view showing velocity variations of an image pickup line according to the construction of the conventional radiographic apparatus.

### DESCRIPTION OF REFERENCES

2 top board
3 radiation source
4 I.I tube (radiation detecting device)
15 image pickup line moving mechanism (radiation source moving device and detector moving device)
16 image pickup line movement control unit (radiation source movement control device and detector movement control device)
21 position information acquiring unit (position information acquiring device)
22 actual velocity acquiring unit (actual velocity acquiring device)
23 acceleration acquiring unit (acceleration acquiring device)
24 target velocity acquiring unit (target velocity acquiring device)
25 velocity difference acquiring unit (velocity difference acquiring device)
26 additional movement control unit (additional movement control device)
27 set value storage unit (set value storage device)
32 console panel (instruction input device)

### BEST MODE FOR CARRYING OUT THE INVENTION

The best mode of the radiographic apparatus according to this invention will be described hereinafter with reference to the drawings. X-rays in the following description are an example of the radiation in this invention.

### Embodiment 1

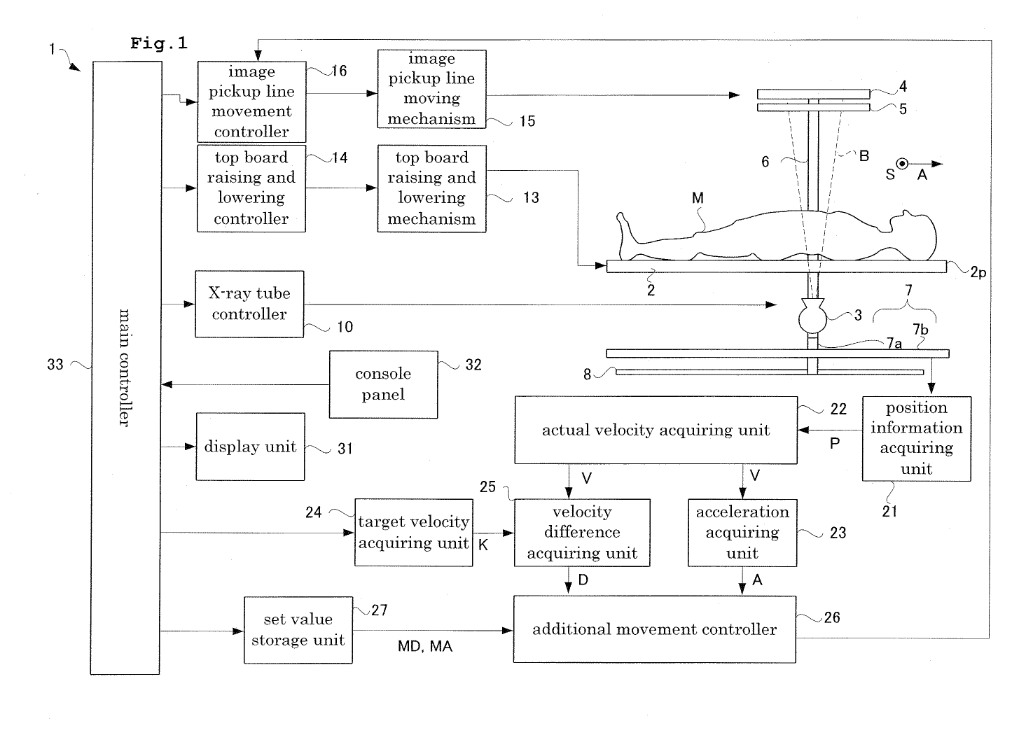

First, the construction of an X-ray apparatus 1 according to Embodiment 1 will be described. FIG. 1 is a functional block diagram illustrating the construction of the X-ray apparatus according to Embodiment 1. As shown in FIG. 1, the X-ray apparatus 1 according to Embodiment 1 includes a top board 2 for supporting a patient M, an X-ray tube 3 disposed below the top board 2 for emitting X-ray beams B in pulse form, an image intensifier (I.I tube) 4 disposed above the top board 2 for detecting X-rays transmitted through the patient M, and an X-ray grid 5 for removing scattered X-rays incident on the I.I tube 4.

The I.I tube 4 is supported by a strut 6 movable along body axis direction A of the patient (which corresponds to the predetermined direction in this invention). The strut 6 is J-shaped to avoid interference with the top board 2. The strut 6 is connected to a slider 7a, and the slider 7a is in contact with a potentiometer main body 7b. The potentiometer main body 7b is in the shape of a rod extending longitudinally of the top board 2 (body axis direction A of the patient M). The slider 7a, with movement of the strut 6, slides back and forth over the surface of the potentiometer main body 7b. Electrodes are provided at opposite ends of the potentiometer main body 7b. When the slider 7a with a predetermined voltage applied thereto moves relative to the potentiometer main body 7b, the potential of the slider 7a will change accordingly. By measuring variations of this potential, positions of the slider 7a relative to the potentiometer main body 7b are known. That is, the slider 7a is provided with an electrode for potential measurement: The slider 7a and potentiometer main body 7b constitute a potentiometer 7 in this invention.

The strut 6 has a proximal portion thereof connected to a belt 8. The X-ray apparatus 1 according to Embodiment 1 includes two pulleys on which the belt 8 is wound, a balance weight connected to the belt 8, and a drive motor for driving the pulleys. These components constitute a specific construction of an image pickup line moving mechanism 15. These components are the same as in the conventional construction, and reference should be made to the Background Art for details. However, in the construction of Embodiment 1, the X-ray tube 3 is attached to the proximal portion of the strut 6. Therefore, with movement of the strut 6, the I.I tube 4 and X-ray tube 3 are moved together. The weight of the balance weight is set not only to the I.I tube 4 but with the weight of the X-ray tube 3 added as well.

The I.I tube 4 and X-ray tube 3 are movable in body side direction S of the patient also. That is, a rail is disposed in a position where the proximal portion of the strut 6 and the belt 8 meet, to extend in the body side direction S of the patient, and the strut 6 is movable along this rail. A similar construction is provided for the X-ray tube 3.

The construction of Embodiment 1 includes an X-ray tube controller 10 for controlling tube voltage and tube current of the X-ray tube 3, and temporal width of the pulse of the X-ray beams B. The construction of Embodiment 1 includes also a top board raising and lowering mechanism 13 for raising and lowering the top board 2, and a top board raising and lowering controller 14 for controlling this. Further, the X-ray apparatus 1 according to Embodiment 1 includes an image pickup line moving mechanism 15 for moving the I.I tube 4, and an image pickup line movement controller 16 for controlling this.

And the X-ray apparatus 1 includes a target velocity acquiring unit 24 for acquiring a target velocity K which is a target moving velocity of the I.I tube 4 based on instructions for movement inputted to an instruction input device, a position information acquiring unit 21 for acquiring position information P showing positions of the I.I tube 4 relative to the top board 2, an actual velocity acquiring unit 22 for acquiring an actual velocity V which is an actual moving velocity of the I.I tube 4 based on the position information P, an acceleration acquiring unit 23 for acquiring acceleration A of the I.I tube 4 based on the actual velocity V, a velocity difference acquiring unit 25 for acquiring a velocity difference D by subtracting the actual velocity V from the target velocity K, an additional movement controller 26 for additionally moving the I.I tube 4 to compensate for the velocity difference D, and a set value storage unit 27 for storing a velocity difference set value MD referred to by the additional movement controller 26, and weighting coefficients as well.

The X-ray apparatus 1 includes also a console panel 32 for receiving instructions from the operator, and a display unit 31 for displaying X-ray fluoroscopic images.

Furthermore, the X-ray apparatus 1 includes a main controller 33 for performing overall control of the X-ray tube controller 10, top board raising and lowering controller 14, image pickup line movement controller 16, position information acquiring unit 21, velocity acquiring unit 22, acceleration acquiring unit 23, target velocity acquiring unit 24, velocity difference acquiring unit 25 and additional movement controller 26. This main controller 33 is formed of a CPU, which executes various programs to realize the respective components. The respective components mentioned above may be realized as divided into arithmetic units in charge thereof.

The X-ray tube 3 emits X-rays toward the patient with a predetermined tube current, tube voltage and irradiation time under control of the X-ray tube controller 10.

The X-ray tube 3 and I.I tube 4 are movable along the body axis direction A of the patient M (longitudinal direction of the top board 2) under control of the image pickup line movement controller 16.

The X-ray grid 5 is disposed to cover the plane of X-ray incidence of the I.I tube 4. This X-ray grid 5 has absorbing foil strips arranged thereon for absorbing scattered X-rays produced inside the patient M. By providing this X-ray grid 5, fluoroscopic images of high contrast can be acquired.

Next, raising and lowering of the top board 2 will be described. The top board 2 is in a state of being laid down in FIG. 1. The top board 2 can be stood up as shown in FIG. 10, and can also be laid down again. The top board raising and lowering mechanism 13 performs the raising and lowering of the top board 2. The top board raising and lowering mechanism 13 raises and lowers the X-ray tube 3, I.I tube 4, strut 6, potentiometer main body 7b and image pickup line moving mechanism 15 together with the top board 2. At this time, the relative positional relationship between each member and top board 2 is maintained. The top board 2 is constructed to stand up with one end 2p in the longitudinal direction thereof (body axis direction A of the patient) moving upward. The upstanding top board 2 lies down again with the one end 2p moving downward.

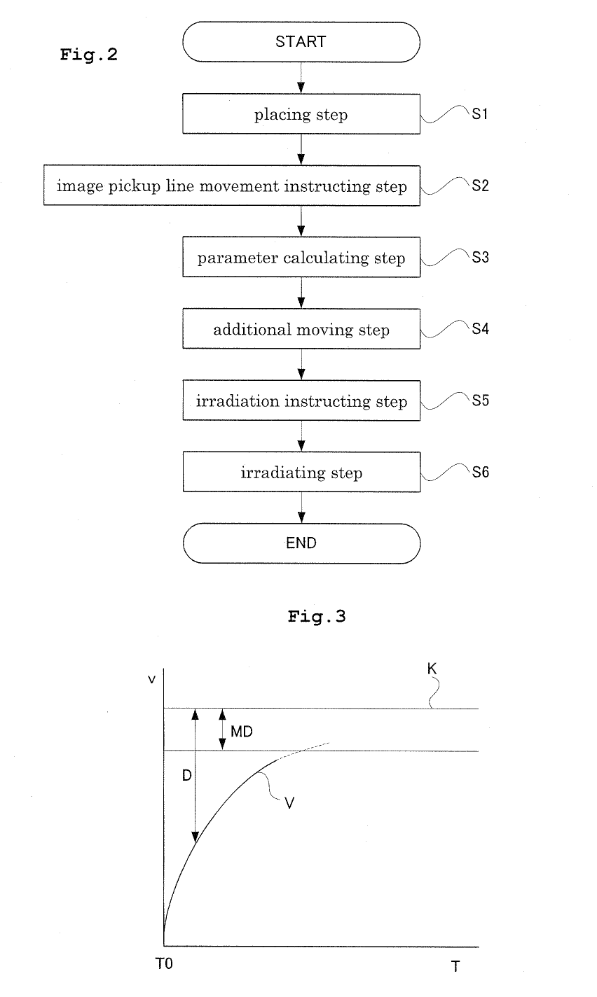

Next, operation of the X-ray apparatus 1 according to Embodiment 1 will be described. FIG. 2 is a flow chart illustrating operation of the radiographic apparatus according to Embodiment 1. An X-ray fluoroscopic image of the patient is acquired with the X-ray apparatus 1 according to Embodiment 1 by executing, in order, various steps consisting of a placing step S1 for placing the patient M, an image pickup line movement instructing step S2 for instructing movement of image pickup line 3, 4, a parameter calculating step S3 for calculating various parameters from position information P on the image pickup line 3, 4, an additional moving step S4 for comparing and checking the various parameters and additionally moving the image pickup line 3, 4, an irradiation instructing step S5 for instructing irradiation with X-rays, and an irradiating step S6 for irradiating the patient M with X-rays. Details of these steps will be described in order hereinafter with reference to the drawings. The following description of operation will be made on the assumption that the top board 2 is laid down, and that an X-ray fluoroscopic image is to be obtained of the patient M placed on the top board 2.

<Placing Step S1 and Image Pickup Line Movement Instructing Step S2>

First, the patient M is placed on the top board 2. It is assumed here that the operator has given instructions, through the console panel 32, to move the image pickup line along the body axis direction A of the patient M. Upon receipt of the instructions from the operator, the main controller 33 outputs a movement instruction signal to the image pickup line movement controller 16, giving instructions for moving the image pickup line 3, 4. The movement instruction signal includes velocity information indicating a velocity for moving the image pickup line 3, 4 and period information indicating a period for the movement. This movement instruction signal is outputted also to the target velocity acquiring unit 24. Consequently, the target velocity acquiring unit 24 will know at what velocity the image pickup line movement controller 16 is going to move the to image pickup line 3, 4. The image pickup line movement controller 16 controls the drive motor of the image pickup line moving mechanism 15 to start movement of the image pickup line 3, 4. This causes the slider 7a to slide under guidance of the potentiometer main body 7b. From this time onward, the potentiometer 7 outputs position signals of the image pickup line 3, 4 to the position information acquiring unit 21.

<Parameter Calculating Step S3>

Based on the position signals received, the position information acquiring unit 21 acquires position information P on the image pickup line 3, 4. The position information acquiring unit 21 acquires the position information P showing positions of the image pickup line 3, 4 relative to the top board 2 by reading electric signals outputted from the potentiometer 7 and performing a linear transformation of these electric signals. This position information P is outputted to the actual velocity acquiring unit 22. The position information P may be outputted to the actual velocity acquiring unit 22 after being converted into digital data by the position information acquiring unit 21.

The actual velocity acquiring unit 22 acquires an actual velocity V through a time differentiation of the position information P. This shows a velocity of the image pickup line 3, 4 when moved by the drive motor. The actual velocity V at this time will be illustrated by an example. As shown in FIG. 3, the image pickup line 3, 4 begins to move at a movement starting time T0. The actual velocity V at time T0 is 0. From this the actual velocity V will increase gradually. The actual velocity V obtained by the actual velocity acquiring unit 22 is outputted to each of the acceleration acquiring unit 23 and velocity difference acquiring unit 25. The acceleration acquiring unit 23 acquires acceleration A through a time differentiation of the actual velocity V. This acceleration A is outputted to the additional movement controller 26.

The target velocity K has been sent to the velocity difference acquiring unit 25 from the target velocity acquiring unit 24 noted hereinbefore. The target velocity K is an expression in velocity of the instructions for moving the image pickup line 3, 4 which the image pickup line movement controller 16 has outputted to the image pickup line moving mechanism 15. There is actually no guarantee for the image pickup line 3, 4 being moved according to this target velocity K. This is because a torque shortage may occur with the drive motor. The target velocity K outputted from the target velocity acquiring unit 24 is a target velocity to be reached by the actual velocity V. Since the actual velocity V at time T0 is 0, the actual velocity V does not reach the target velocity K immediately. For providing an X-ray fluoroscopic image 1 of excellent operability, it is necessary to bring the actual velocity V to the target velocity K smoothly while preventing an overshoot.

The velocity difference acquiring unit 25 acquires a current velocity difference D based on the target velocity K and actual velocity V outputted as required. That is, the actual velocity V at a certain time is subtracted from the target velocity K at the certain time, and the result is regarded as velocity difference D (see FIG. 3). The velocity difference D is outputted to the additional movement controller 26.

<Additional Moving Step S4>

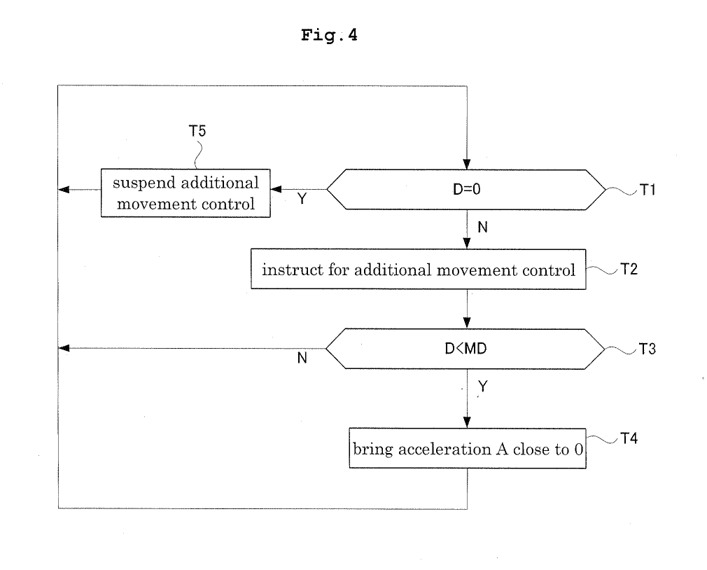

Next, the additional moving step S4 which is the most characteristic portion of the construction of Embodiment 1 will be described. Operation of the additional movement controller 26 is shown in the flow chart of FIG. 4. The operation of the additional movement controller 26 includes a first substep T1 for checking whether an additional movement is to be made, a third substep T3 for determining a velocity difference, and a fourth substep T4 for giving instructions for bringing the acceleration of the image pickup line close to 0.

<First Substep T1 and Second Substep T2>

When the velocity difference D is not 0, the additional movement controller 26 recognizes a need to additionally increase a controlled variable (controlled variable) of movement of the image pickup line 3, 4, and instructs the image pickup line movement controller 16 to move the image pickup line 3, 4 in a way to additionally increase the controlled variable, in addition to the current movement of the image pickup line 3, 4.

<Third Substep T3>

The additional movement controller 26 compares the velocity difference set value MD stored in the set value storage unit 27 and the velocity difference D. When the velocity difference D is smaller than the velocity difference set value MD (see FIG. 3), the additional movement controller 26 recognizes a need to calculate an additional controlled variable corresponding to velocity and acceleration, and reads weighting coefficients α and β of velocity and acceleration, respectively, stored in the set value storage unit 27.

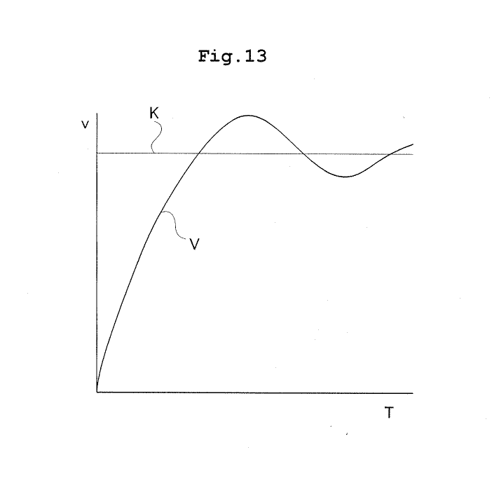

When the determination in third substep T3 is “yes”, it means that the velocity difference D is small, and means that the actual velocity V is approaching the target velocity K. If high acceleration A is maintained as it is, its momentum will force the actual velocity V to exceed the target velocity K. This will give rise to a necessity to slow down the image pickup line 3, 4 in order to eliminate the excess, or an overshoot will occur as shown in FIG. 13.

<Fourth Substep T4>

In order to prevent overshooting, the additional movement controller 26 gives instructions to bring the current acceleration A of the image pickup line 3, 4 close to 0. An additional controlled variable for bringing the acceleration close to 0 is obtained by adding the velocity difference D multiplied by the weighting coefficient α, and a ratio of the acceleration A to the velocity difference D multiplied by the weighting coefficient β. Here, α is a positive coefficient and β a negative coefficient. That is, additional controlled variable X can be expressed as set out hereunder. The weighting coefficient α corresponds to the first weighting coefficient in this invention, and the weighting coefficient β corresponds to the second weighting coefficient in this invention. The additional movement controller 26 calculates this additional controlled variable X.

X=α×D+β(A/D)

In fourth substep T4, although the actual velocity V is approaching the target velocity K, the acceleration A is assumed to be excessive. When high acceleration A is maintained as it is, overshooting will occur. So, in order to prevent it, the additional movement controller 26 is constructed to instruct the image pickup line movement controller 16 to bring the acceleration A of the image pickup line 3, 4 close to 0.

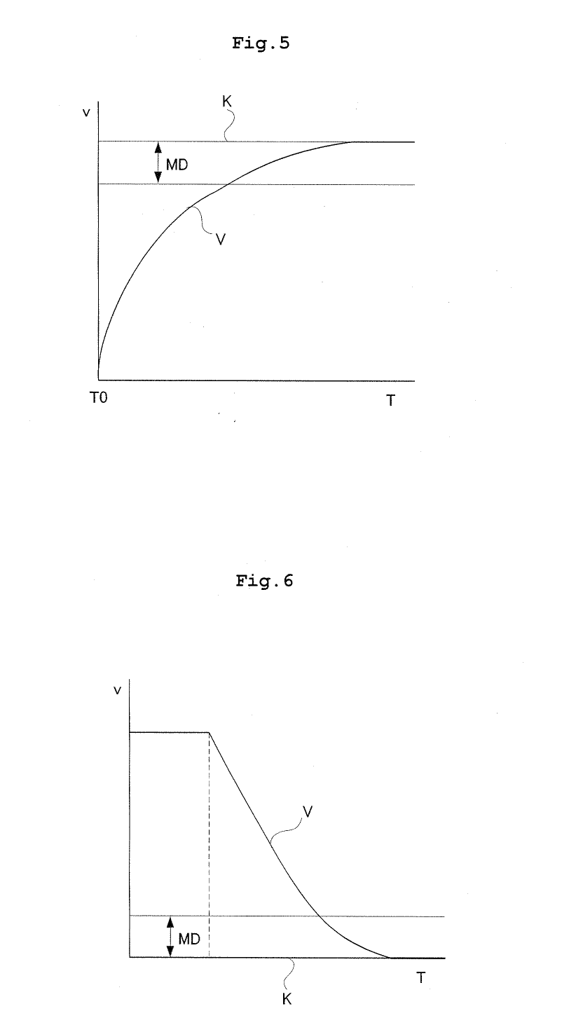

The additional movement controller 26 executes first substep T1 again to continue monitoring the velocity difference D. Since the acceleration A is reduced when the actual velocity V approaches the target velocity K, as shown in FIG. 5, the actual velocity V gradually approaches the target velocity K, and never exceeds the target velocity K after all. When the velocity difference D is 0, the additional movement control is suspended (fifth substep T5).

The above description describes operation of the additional movement controller 26 at a time of starting movement of the image pickup line 3, 4. Similar operation is not limited to the above example, but the additional movement controller 26 operates as described above when changing the velocity of the image pickup line 3, 4 as when stopping the image pickup line, 3, 4. When stopping the image pickup line 3, 4, as shown in FIG. 6, the target velocity K is 0. With the operation of the additional movement controller 26, the actual velocity V gradually approaches the target velocity K and eventually becomes 0. Such construction can prevent a phenomenon in which an overshoot occurs immediately before the image pickup line 3, 4 is stopped, causing the image pickup line 3, 4 to vibrate immediately before stopping.

<Irradiation Instructing Step S5 and Irradiating Step S6>

When the movement of the image pickup line 3, 4 is completed, the operator instructs the X-ray apparatus 1 through the console panel 32 to start irradiation with X-rays. Then, the X-ray tube controller 10 controls the X-ray tube 3 according to the tube voltage, tube current and irradiation time inputted by the operator through the console panel 32. In this way, the X-ray tube 3 emits X-rays toward the patient M, X-rays transmitted through the patient M fall on the plane of incidence of the I.I tube 4, and an X-ray fluoroscopic image projected to the I.I tube 4 is displayed on the display unit 31. This completes acquisition of the X-ray fluoroscopic image in the X-ray apparatus 1 according to Embodiment 1.

According to the construction of Embodiment 1, as described above, an actual velocity V which is a moving velocity of the image pickup line 3, 4 is acquired, and a velocity difference D is obtained by subtracting the above actual velocity V from a target velocity K which is based on instructions of the operator. The additional movement controller 26 additionally increases a controlled variable of movement of the image pickup line 3, 4 so as to compensate for the velocity difference D. This construction enables feedback control for recurrently controlling the movement of the image pickup line 3, 4. Moreover, the construction of Embodiment 1 is characterized by obtaining acceleration A of the image pickup line 3, 4. For providing the X-ray apparatus 1 capable of moving the image pickup line 3, 4 as specified by the operator, it is important that the additional movement controller 26 monitors acceleration A of the image pickup line 3, 4. That is, when the actual velocity V is slightly lower than the target velocity K, and the image pickup line 3, 4 is moved by additionally increasing the controlled variable of movement without regard to the acceleration A, the actual velocity V will exceed the target velocity K, the actual velocity V becoming slightly higher than the target velocity K. When the image pickup line 3, 4 is additionally moved in order to bring the actual velocity V to the target velocity K, the actual velocity V will then become less than the target velocity K. That is, overshooting of the actual velocity V will take place.

However, according to Embodiment 1, when the actual velocity V is close to the target velocity K, and the acceleration A is so large as to cause overshooting, the acceleration A of the image pickup line 3, 4 is brought close to 0. In this way, the actual velocity V will gradually approach the target velocity K, and the actual velocity V will never increase or decrease across the target velocity K. Then, the above overshooting can be inhibited, and the phenomenon of the image pickup line 3, 4 clattering each time it moves can be prevented reliably, thereby providing the X-ray apparatus 1 excellent in operability.

This invention is not limited to the construction of the foregoing embodiment, but may be modified as follows.

(1) The foregoing embodiment employs the I.I tube 4 as the radiation detecting device, but this invention is not limited to this. A flat panel detector may be used instead of the I.I tube 4.

(2) The foregoing embodiment relates to a medical apparatus, but this invention is not limited to this. This invention is applicable also to the industrial field and nuclear field.

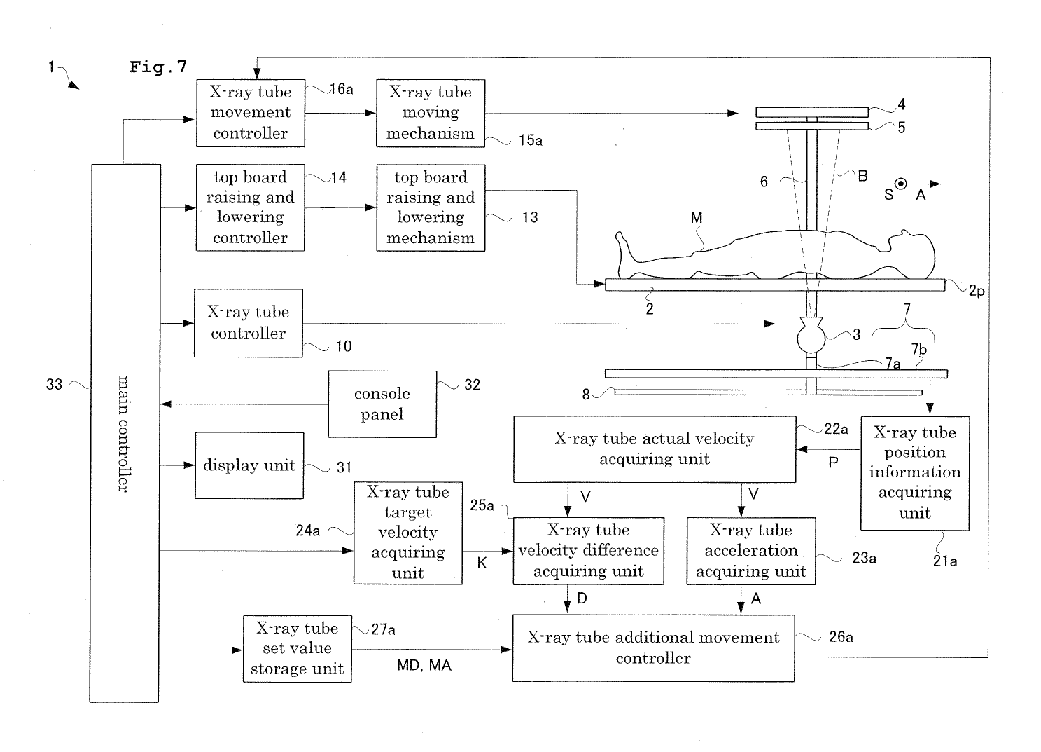

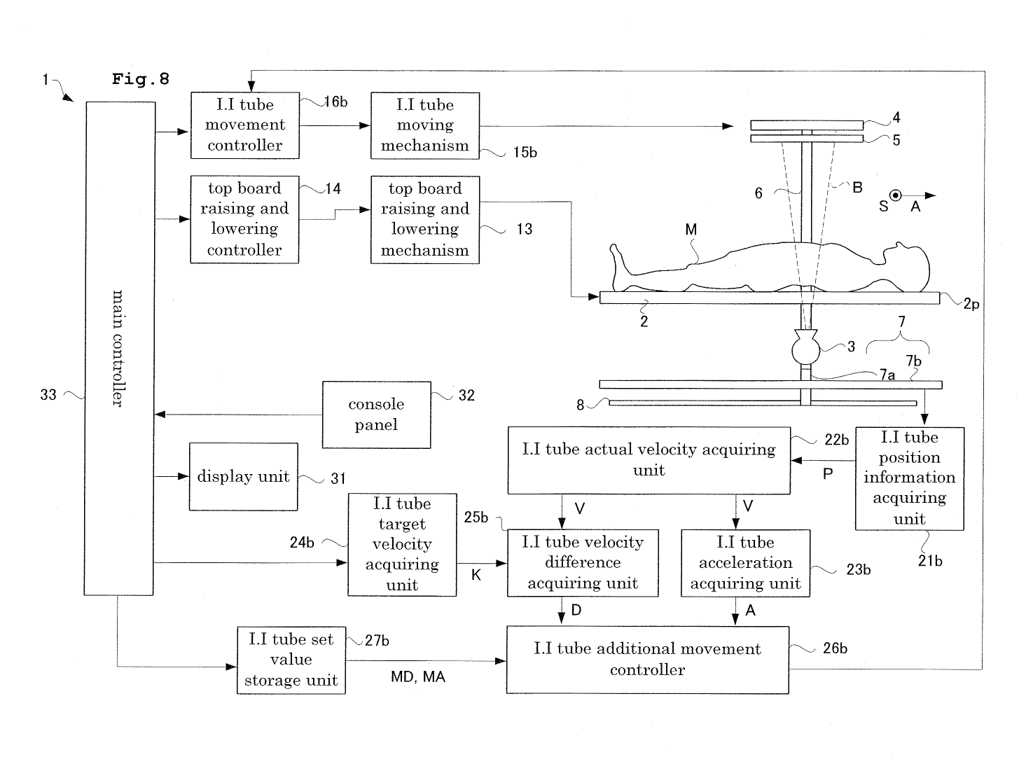

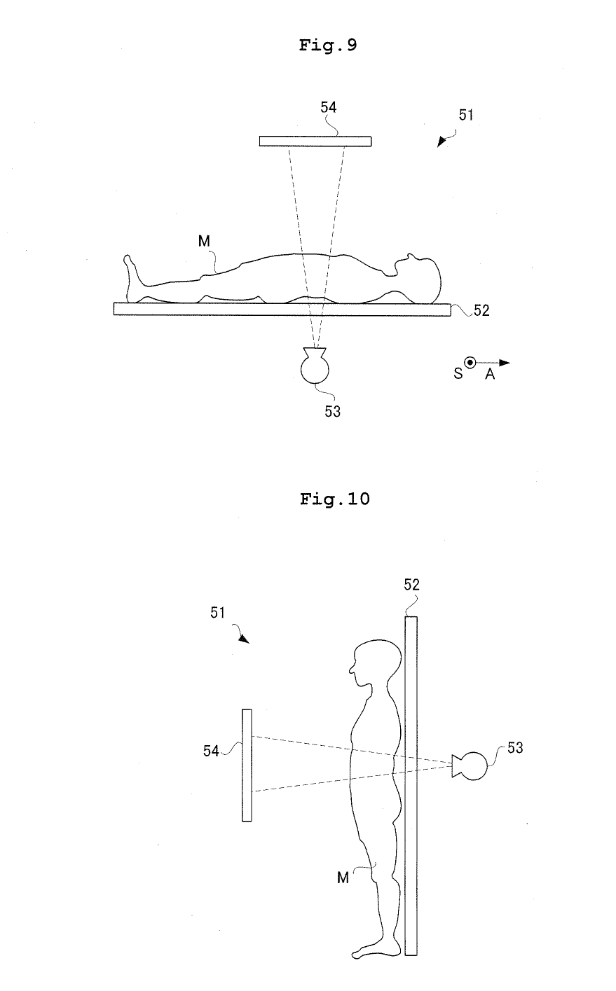

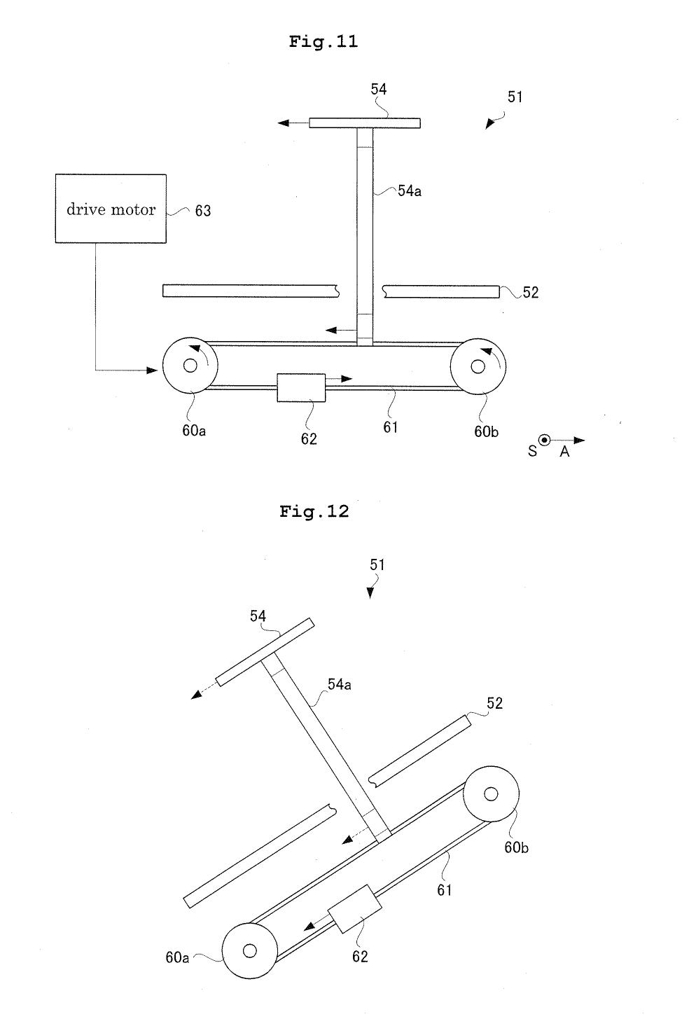

(3) In the foregoing embodiment, the image pickup line movement controller corresponds to the radiation source movement control device and the detector movement control device in this invention, but this can be made independent components. That is, as shown in FIGS. 7 and 8, the construction may be modified to include an X-ray tube movement controller 16a and an I.I tube movement controller 16b instead of the image pickup line movement controller. Further, as shown in FIGS. 7 and 8, the construction may be modified to include an X-ray tube moving mechanism 15a and an I.I tube moving mechanism 15b instead of the image pickup line moving mechanism. The X-ray tube moving mechanism 15a and I.I tube moving mechanism 15b make a construction having two image pickup line moving mechanisms provided independently for the X-ray tube 3 and I.I tube 4 in Embodiment 1.

FIG. 7 collectively records the components relating to the X-ray tube 3. As shown in FIG. 7, the X-ray apparatus 1 according to this modification, in place of the image pickup line moving mechanism 15, image pickup line movement controller 16, position information acquiring unit 21, actual velocity acquiring unit 22, acceleration acquiring unit 23, target velocity acquiring unit 24, velocity difference acquiring unit 25, additional movement controller 26 and set value storage unit 27 relating to the movement of the image pickup line 3, 4 in Embodiment 1, includes an X-ray tube moving mechanism 15a, X-ray tube movement controller 16a, X-ray tube position information acquiring unit 21a, X-ray tube actual velocity acquiring unit 22a, X-ray tube acceleration acquiring unit 23a, X-ray tube target velocity acquiring unit 24a, X-ray tube velocity difference acquiring unit 25a, X-ray tube additional movement controller 26a and X-ray tube set value storage unit 27a relating only to movement of the X-ray tube 3, respectively.

. FIG. 8 collectively records the components relating to the I.I tube 4. As shown in FIG. 8, the X-ray apparatus 1 according to this modification, in place of the image pickup line moving mechanism 15, image pickup line movement controller 16, position information acquiring unit 21, actual velocity acquiring unit 22, acceleration acquiring unit 23, target velocity acquiring unit 24, velocity difference acquiring unit 25, additional movement controller 26 and set value storage unit 27 relating to the movement of the image pickup line 3, 4 in Embodiment 1, includes an I.I tube moving mechanism 15b, I.I tube movement controller 16b, I.I tube position information acquiring unit 21b, I.I tube actual velocity acquiring unit 22b, I.I tube acceleration acquiring unit 23b, I.I tube target velocity acquiring unit 24b, I.I tube velocity difference acquiring unit 25b, I.I tube additional movement controller 26b and I.I tube set value storage unit 27b relating only to movement of the I.I tube 4, respectively.

(4) While Embodiment 1 uses a threshold consisting in the velocity difference set value MD, a construction not using this is possible. That is, additional controlled variables X can be obtained one after another during the period of movement of the image pickup line 3, 4. In this construction, the additional controlled variables X will gradually increase with increase of the velocity difference D, and will gradually increase with decrease of the acceleration A. Then, the moving velocity of the image pickup line 3, 4 can be brought close to the target velocity K promptly.

This embodiment includes both the components relating to the movement of the X-ray tube 3 and the components relating to the movement of the I.I tube 4. A construction realizing feedback controls of the X-ray tube 3 and I.I tube 4 independent of each other may be provided.

### INDUSTRIAL UTILITY

As described above, this invention is suitable for a radiographic apparatus for medical use.

1. A radiographic apparatus having a top board, a radiation source for emitting radiation beams to the top board, a radiation detecting device for detecting the radiation beams, a radiation source moving device for moving the radiation source back and force in a predetermined direction relative to the top board, a radiation source movement control device for controlling this, a detector moving device for moving the radiation detecting device back and force in the predetermined direction relative to the top board, a detector movement control device for controlling this, and an instruction input device for inputting instructions for movement of a movable object which is at least one of the radiation source and the radiation detecting device,
the radiographic apparatus comprising:
a target velocity acquiring device for acquiring a target velocity, which is a target moving velocity of the movable object, based on input of the instruction input device;
a position information acquiring device for acquiring position information showing positions of the movable object relative to the top board;
an actual velocity acquiring device for acquiring an actual velocity of the movable object, based on the position information;
an acceleration acquiring device for acquiring an acceleration of the movable object based on the actual velocity;
a velocity difference acquiring device for acquiring a velocity difference by subtracting the actual velocity from the target velocity; and
an additional movement control device for additionally moving the movable object to compensate for the velocity difference;
wherein the additional movement control device is arranged to move the movable object to bring the acceleration close to 0.

2. The radiographic apparatus according to claim 1, further comprising:
a set value storage device for storing a velocity difference setting to be referred to by the additional movement control device;
wherein the additional movement control device is arranged, when the velocity difference is smaller than the velocity difference set value, to move the movable object to bring the acceleration close to 0.

3. The radiographic apparatus according to claim 1, wherein the movable object is the radiation detecting device.

4. The radiographic apparatus according to claim 1, wherein the position information acquiring device is a potentiometer.

5. The radiographic apparatus according to claim 1, further comprising:
a top board raising and lowering mechanism for raising and lowering the top board, and a top board raising and lowering control device for controlling this;
wherein the top board is arranged to stand up with one end in a longitudinal direction thereof moving upward, the top board standing up being arranged to lie down with the one end in the longitudinal direction thereof moving downward;
the radiation source, the radiation source moving device, the radiation detecting device and the detector moving device are arranged, when the top board is raised and lowered, to move with the top board while maintaining a positional relationship with the top board; and
the predetermined direction is the longitudinal direction of the top board.

6. The radiographic apparatus according to claim 1, wherein:
the set value storage device is arranged to store also a first weighting coefficient and a second weighting coefficient; and
a controlled variable of additional movement made by the additional movement control device is a sum of the velocity difference multiplied by the first weighting coefficient and a ratio of the acceleration to the velocity difference multiplied by the second weighting coefficient.

7. The radiographic apparatus according to claim 2, wherein the movable object is the radiation detecting device.

8. The radiographic apparatus according to claim 2, wherein the position information acquiring device is a potentiometer.

9. The radiographic apparatus according to claim 3, wherein the position information acquiring device is a potentiometer.

10. The radiographic apparatus according to claim 2, further comprising:
a top board raising and lowering mechanism for raising and lowering the top board, and a top board raising and lowering control device for controlling this;
wherein the top board is arranged to stand up with one end in a longitudinal direction thereof moving upward, the top board standing up being arranged to lie down with the one end in the longitudinal direction thereof moving downward;
the radiation source, the radiation source moving device, the radiation detecting device and the detector moving device are arranged, when the top board is raised and lowered, to move with the top board while maintaining a positional relationship with the top board; and
the predetermined direction is the longitudinal direction of the top board.

11. The radiographic apparatus according to claim 3, further comprising:
a top board raising and lowering mechanism for raising and lowering the top board, and a top board raising and lowering control device for controlling this;
wherein the top board is arranged to stand up with one end in a longitudinal direction thereof moving upward, the top board standing up being arranged to lie down with the one end in the longitudinal direction thereof moving downward;
the radiation source, the radiation source moving device, the radiation detecting device and the detector moving device are arranged, when the top board is raised and lowered, to move with the top board while maintaining a positional relationship with the top board; and
the predetermined direction is the longitudinal direction of the top board.

12. The radiographic apparatus according to claim 4, further comprising:
a top board raising and lowering mechanism for raising and lowering the top board, and a top board raising and lowering control device for controlling this;
wherein the top board is arranged to stand up with one end in a longitudinal direction thereof moving upward, the top board standing up being arranged to lie down with the one end in the longitudinal direction thereof moving downward;
the radiation source, the radiation source moving device, the radiation detecting device and the detector moving device are arranged, when the top board is raised and lowered, to move with the top board while maintaining a positional relationship with the top board; and
the predetermined direction is the longitudinal direction of the top board.

13. The radiographic apparatus according to claim 2, wherein:
the set value storage device is arranged to store also a first weighting coefficient and a second weighting coefficient; and
a controlled variable of additional movement made by the additional movement control device is a sum of the velocity difference multiplied by the first weighting coefficient and a ratio of the acceleration to the velocity difference multiplied by the second weighting coefficient.

14. The radiographic apparatus according to claim 3, wherein:
the set value storage device is arranged to store also a first weighting coefficient and a second weighting coefficient; and
a controlled variable of additional movement made by the additional movement control device is a sum of the velocity difference multiplied by the first weighting coefficient and a ratio of the acceleration to the velocity difference multiplied by the second weighting coefficient.

15. The radiographic apparatus according to claim 4, wherein:
the set value storage device is arranged to store also a first weighting coefficient and a second weighting coefficient; and
a controlled variable of additional movement made by the additional movement control device is a sum of the velocity difference multiplied by the first weighting coefficient and a ratio of the acceleration to the velocity difference multiplied by the second weighting coefficient.

16. The radiographic apparatus according to claim 5, wherein:
the set value storage device is arranged to store also a first weighting coefficient and a second weighting coefficient; and
a controlled variable of additional movement made by the additional movement control device is a sum of the velocity difference multiplied by the first weighting coefficient and a ratio of the acceleration to the velocity difference multiplied by the second weighting coefficient.
